(19) United States
(12) Patent Application Publication
(10) Pub. No.: US 2015/0024757 A1
(43) Pub. Date: Jan. 22, 2015

(54) MEASURES IN CASE OF HANDOVER PROBLEMS IN CASE OF RELAYING

(71) Applicants: Omer Bulakci, Munich (DE); Ahmad Awada, Munich (DE); Ingo Viering, Munich (DE); Simone Redana, Munich (DE)

(72) Inventors: Omer Bulakci, Munich (DE); Ahmad Awada, Munich (DE); Ingo Viering, Munich (DE); Simone Redana, Munich (DE)

(73) Assignee: NOKIA SOLUTIONS AND NETWORKS OY, Espoo (FI)

(21) Appl. No.: 14/377,589

(22) PCT Filed: Feb. 16, 2012
(86) PCT No.: PCT/EP2012/052716

§ 371 Date: Aug. 8, 2014

(51) Int. Cl. H04W 36/00

(52) U.S. Cl. CPC H04W 36/0016; H04W 36/0072; H04W 88/04
USPC 455/437; 455/11.1

(57) ABSTRACT

An apparatus and a method are described, by which communication from at least one network control node is relayed to at least one user equipment and vice versa, it is detected whether a connection to a network control node or a handover of the apparatus from a serving network control node to a target network control node for maintaining a network connection of the at least one user equipment is required but not possible, and, in case the connection or the handover is not possible, the at least one user equipment is instructed to perform a handover to a network control node.

This application is a national stage entry of PCT Application No. PCT/EP2012/052716, filed on Feb. 16, 2012, entitled “MEASURES IN CASE OF HANDOVER PROBLEMS IN CASE OF RELAYING”, which is hereby incorporated by reference in its entirety.

### FIELD OF THE INVENTION

The present invention relates to apparatuses, methods and a computer program product for handling handover problems in case of relaying.

### RELATED BACKGROUND ART

The following descriptions for the abbreviations used in this specification apply:
ABS Almost Blank Subframe
Alt Alternative
DeNB Donor eNB
eICIC enhanced Inter-Cell Interference Coordination
eNB enhanced Node B
E-UTRA Evolved Universal Terrestrial Radio Access
GW Gateway
HO Handover
ICIC Inter-Cell Interference Coordination
LTE Long Term Evolution
LTE-A LTE-Advanced
MBSFN Multi-Media Broadcast over a Single Frequency Network
MME Mobility Management Entity
PGW Packet Data Network Gateway
QoS Quality of Service
RAT Radio Access Technology
Rel. Release
RLF Radio Link Failure
RN Relay Node
RSCP Reference Signal Code Power
RSRP Reference Signal Received Power
SGW Serving Gateway
SON Self Organizing Network
Tx Transmission
UE User equipment

Embodiments of the present invention relate LTE-Advanced, and in particular to relaying.

Relaying is considered for LTE-Advanced as a tool to improve, e.g. the coverage of high data rates, group mobility, temporary network deployment, the cell-edge throughput and/or to provide coverage in new areas. Fixed relay as an important topic for Release (Rel.) 10 has been standardized in 3GPP. In a relay system, relay node (RN) acts as UE from DeNB point of view, while it behaves as an eNB for the UEs served by the RN. Therefore, the RN supports eNB functionality as well as UE functionality.

FIG. 2 shows a relay system architecture. It is noted that Alt1 to Alt3 show different alternatives of which elements are to be considered as part of the relay system. For example, Alt2 was selected by 3GPP for fixed relay implementation in Release 10.

Hitherto, only fixed relay for coverage extension scenario was discussed extensively in Rel. 10. However, moving relays (relay nodes (RNs)), also referred to as mobile relays, are also of great interest, for example in high speed train infrastructure. Therefore, moving relay nodes, as an important candidate feature, will be investigated in Rel. 11. In addition to the application area for the high speed trains, moving relay nodes can be also mounted on busses, trams, ferries, and any other kind of vehicles depending on the target service. An example high speed train scenario is illustrated in FIG. 3 where a multiple of RNs are mounted on train carriages. It is worth noting that the access link antennas of the moving relay node are installed inside the carriage and the backhaul link antennas are installed outside the carriage. Such a configuration prevents penetration loss.

However, when applying moving relay nodes, problems might occur when performing handovers from one DeNB to another DeNB (so-called backhaul HO) due to, e.g. the speed of the moving relay nodes and load conditions in the target DeNB. That is, such a handover may fail or is not even possible in certain situations, e.g. when the target macrocell does not have DeNB functionality. Hence, a connection of the UEs served by the moving relay nodes cannot always be ensured.

### SUMMARY OF THE INVENTION

Embodiments of the present invention address this situation and aim to provide a reliable connection even in case of moving relay nodes.

According to a first aspect of the present invention an apparatus is provided which comprises a first connection unit configured to provide connection to at least one network control node, a second connection unit configured to provide connection to at least one user equipment, and a processor configured to relay communication from the at least one network control node via the first connection unit to the at least one user equipment via the second connection unit and vice versa, to detect that a connection to a network control node or a handover of the apparatus from a serving network control node to a target network control node for maintaining a network connection of the at least one user equipment is required but not possible, and, in case the connection or the handover is not possible, to instruct the at least one user equipment to perform a handover to a network control node.

The apparatus may be configured to switch off the second connection unit in case the apparatus is unable to establish a connection or to perform a handover.

The processor may be configured to blink on a set of resource blocks and to switch off the second connection unit.

The processor may further be configured to blink on a set of resource blocks and inform the target network control node about the set of resource blocks on which blinking is performed.

The processor may further be configured
to hand over the at least one user equipment blindly or
to configure the at least one user equipment with measurements for preparing an inter radio access technology handover or an inter-frequency handover.

The processor may further be configured to receive an instruction from the serving network control node or a network organizing device informing about the set resource blocks on which blinking is to be performed.

The processor may further be configured to coordinate the set of resource blocks on which blinking is to be performed with another relay node.

The processor may further be configured to instruct the handover of the at least one user equipment when a message informing that the handover of the apparatus from the serving network control node to the target network control node for maintaining the network connection of the at least one network control node is not possible is received via the first connection unit in case the target network control node is a network control node capable of serving a relay node.

The processor may further be configured to instruct the handover of the at least one user equipment when a certain measurement event expires in case the target network control node is a network control node not capable of serving a relay node or a network control node capable of serving a relay node, wherein in the certain measurement event, the processor is configured to perform measurements of transmission power of the serving network control node and of the target network control node and the event expires

when the measured transmission power of the serving network control node is at most a predetermined difference value over the measured transmission power of the target network control node for a predetermined time, or

when the measured transmission power of the serving network control node is below the measured transmission power of the target network control node by at least a predetermined difference value for a predetermined time.

Further a plurality of user equipments may be connected with the second connection unit, and the processor may be configured to instruct only a part of the plurality of user equipments to perform a handover to a network control node.

The processor may further be configured to select the part of the plurality of user equipments which are to be instructed to perform a handover based on a criterion for the user equipments and/or based on service related information of the target network control node.

The processor may further be configured to, before selecting the part of the plurality of user equipments which are to be instructed to perform a handover, request the service related information from the target network control node.

Said criterion for the user equipment may comprise quality of service requirements and/or quality of experience, and/or the service related information requested from the target network control node may comprise a handover load offered by the target network control node.

According to a second aspect of the present invention an apparatus is provided which comprises a connection unit configured to provide connection to at least a first and a second relay node, and a processor configured to coordinate blinking on a set of resource blocks by the at least first and the second relay node.

The processor may be configured to receive information regarding blinking on the set of resource blocks from the first relay node and/or the at least second relay node.

The processor may further be configured to perform relaying communication to at least one user equipment via the connection unit through the at least first relay node.

According to a third aspect of the present invention an apparatus is provided which comprises a first connection unit configured to provide connection to a first network control node, a second connection unit configured to provide connection to at least one user equipment, and a processor configured to relay communication from the at least one network control node via the first connection unit to the at least one user equipment via the second connection unit and vice versa, and to perform blinking on a set of resource blocks.

The processor may be configured to receive an instruction to blink on a set of resource blocks from the serving network control node or a network organizing device, and/or to coordinate blinking on a set of resource blocks with another relay node.

According to a fourth aspect of the present invention an apparatus is provided which comprises a connection unit configured to provide connection to a first relay node, and a processor configured to perform relaying communication to at least one user equipment via the connection unit through the relay node, to receive, via the connection unit, a request from the relay node for service related information of the apparatus, and to send an answer to the request to the relay node via the connection unit.

The service related information requested by the relay node may comprise a handover load offered by the apparatus.

According to a fifth aspect of the present invention a method is provided which comprises relaying, in a relay node, communication from at least one network control node to at least one user equipment and vice versa, detecting that a connection to a network control node or a handover of the relay node from a serving network control node to a target network control node for maintaining a network connection of the at least one user equipment is required but not possible, and, in case the connection or the handover is not possible, instructing the at least one user equipment to perform a handover to a network control node.

The method may further comprise switching off a connection unit of the relay node for providing connection to the user equipment in case the relay node is unable to establish a connection or to perform a handover.

The method may further comprise blinking on a set of resource blocks and to switch off a connection unit of the relay node for providing connection to the user equipment.

The method may further comprise blinking on a set of resource blocks and informing the target network control node about the set of resource blocks on which blinking is performed.

The method may further comprise handing over the at least one user equipment blindly or configuring the at least one user equipment with measurements for preparing an inter radio access technology handover or an inter-frequency handover.

The method may further comprise receiving an instruction from the serving network control node or a network organizing device informing about the set resource blocks on which blinking is to be performed.

The method may further comprise coordinating the set of resource blocks on which blinking is to be performed with another relay node.

The method may further comprise instructing the handover of the at least one user equipment when a message informing that the handover of the apparatus from the serving network control node to the target network control node for maintaining the network connection of the at least one network control node is not possible is received in case the target network control node is a network control node capable of serving a relay node.

The method may further comprise instructing the handover of the at least one user equipment when a certain measurement event expires in case the target network control node is a network control node not capable of serving a relay node or a network control node capable of serving a relay node, wherein in the certain measurement event, measurements of transmission power of the serving network control node and of the target network control node are performed, and the event expires when the measured transmission power of the serving network control node is at most a predetermined difference value over the measured transmission power of the target network control node for a predetermined time, or when the measured transmission power of the serving network control node is below the measured transmission power of the target network control node by at least a predetermined difference value for a predetermined time.

A plurality of user equipments may be connected with the second connection unit, and the method may further comprise instructing only a part of the plurality of user equipments to perform a handover to a network control node.

The method may further comprise selecting the part of the plurality of user equipments which are to be instructed to perform a handover based on a criterion for the user equipments and/or based on service related information of the target network control node.

The method may further comprise requesting the service related information from the target network control node before selecting the part of the plurality of user equipments which are to be instructed to perform a handover.

The criterion for the user equipment may comprise quality of service requirements and/or quality of experience, and/or the service related information requested from the target network control node comprises a handover load offered by the target network control node.

According to a sixth aspect of the present invention a method is provided which comprises coordinating blinking on a set of resource blocks by at least a first and a second relay node.

The method may further comprise receiving information regarding blinking on the set of resource blocks from the first relay node and/or the at least second relay node.

The method may further comprise relaying communication to at least one user equipment through the at least first relay node.

According to a seventh aspect of the present invention a method is provided which comprises relaying communication from at least one network control node to at least one user equipment and vice versa, and performing blinking on a set of resource blocks.

The method may further comprise receiving an instruction to blink on a set of resource blocks from a serving network control node or a network organizing device, and/or to coordinate blinking on a set of resource blocks with another relay node.

According to an eighth aspect of the present invention a method is provided which comprises performing, in a network control node, relaying communication to at least one user equipment through a relay node, receiving a request from the relay node for service related information of the network control node, and sending an answer to the request to the relay node.

The service related information requested by the relay node may comprise a handover load offered by the network control node.

### BRIEF DESCRIPTION OF THE DRAWINGS

These and other objects, features, details and advantages will become more fully apparent from the following detailed description of embodiments of the present invention which is to be taken in conjunction with the appended drawings, in which:

FIG. 1 shows basis structures for a DeNB and an RN according to general embodiments of the present invention,

FIG. 2 shows a general relay system architecture,

FIG. 3 shows a moving relay illustration for a high speed train scenario,

FIG. 4 illustrates a scenario where a backhaul HO failure/rejection or partial admittance may take place according to a specific embodiment 1 of the present invention,

FIG. 5 shows an event R3 mechanism according to a specific embodiment 2 of the present invention,

FIG. 6 shows an inter-RAT scenario according to a specific embodiment 3 of the present invention,

FIG. 7 shows a basis structure for a SON entity according to a general embodiment of the present invention, and

FIG. 8 shows a SON entity in a high speed train scenario.

### DETAILED DESCRIPTION OF EMBODIMENTS

In the following, description will be made to embodiments of the present invention. It is to be understood, however, that the description is given by way of example only, and that the described embodiments are by no means to be understood as limiting the present invention thereto.

As described above, embodiments of the present invention relate to solving problems in connection with handovers of relay nodes, in particular moving relay nodes (RN).

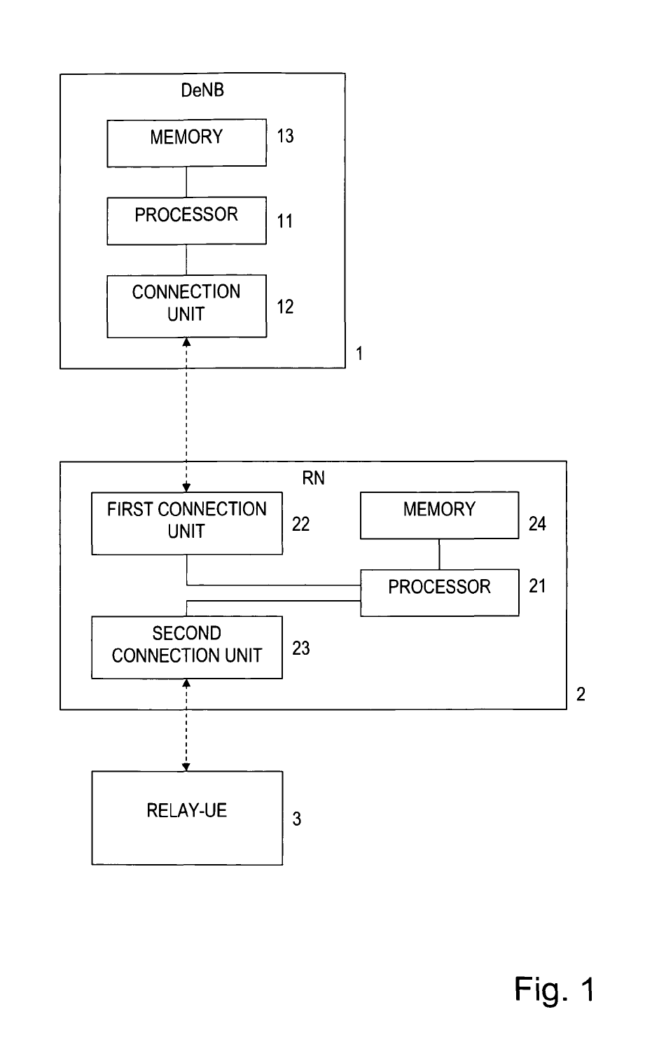

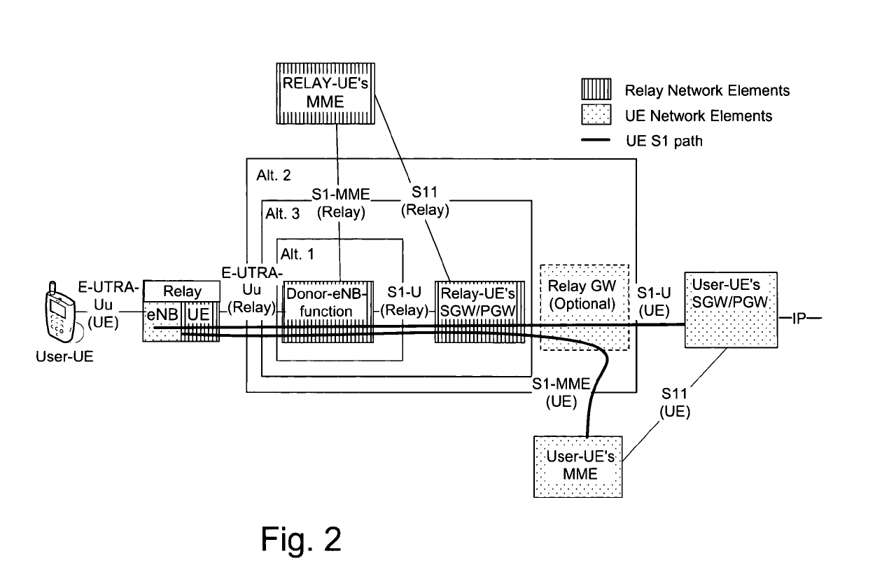

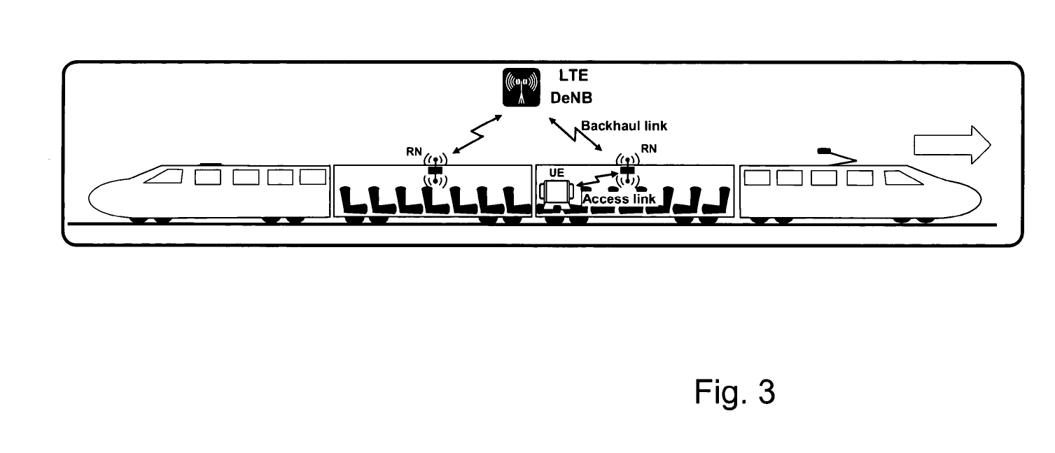

A general embodiment is described in the following by referring to FIG. 1, in which some examples for apparatuses according to embodiments are shown.

FIG. 1 shows a relay node (RN) 2 as an example for an apparatus (which may be a relay node but also only a part thereof) according to a general embodiment of the present invention. The RN 2 comprises a first connection unit 22 (e.g., transceiver), a second connection unit 23 (e.g., transceiver) and a processor 21. The first connection unit 22 is configured to provide connection to a first network control node (such as DeNB 1 shown in FIG. 1, for example), and the second connection unit 23 is configured to provide connection to at least one user equipment (e.g., the relay-UE 3 shown in FIG. 1). The processor 21 is configured to relay communication from the at least one network control node via the first connection unit 22 to the at least one user equipment via the second connection unit 23 and vice versa, to detect that a connection to a network control node or a handover of the apparatus from a serving network control node to a target network control node for maintaining a network connection of the at least one user equipment is required but not possible, and, in case the connection or the handover is not possible, to instruct the at least one user equipment to perform a handover to a network control node.

That is, in case it is not possible for a relay node to perform a handover to a new network control node (such as a DeNB), the user equipment(s) (in the following also referred to as relay-UE(s)) attached to the relay node are instructed to perform a handover to a suitable other network control node themselves.

That is, a relay node, in particular a moving relay node may initiate handovers of its relay-UEs to other target cell(s) (DeNB, eNB, 2G/3G, Inter-frequency cell, etc.) in case the moving relay node is unable to connect or fails to handover to a target macrocell. The other target cell for the relay-UEs can be any other access node that is capable of serving a user equipment or the user equipment can be handed over to, e.g. picocells. Note that the target macrocell, which is capable of serving a moving relay, is referred to as DeNB herein, whereas, it can be any other access node when it is incapable of serving a moving relay.

The RN 2 may also comprise a memory 24 for storing data and programs, by means of which the processor 21 may carry out its corresponding functions.

It is noted that in the following the DeNB is an example for a network control node capable of serving a relay node, and the eNB is an example for a network control node not capable of serving a relay node. Furthermore, a user equipment served by a relay node (RN) is also referred to as relay-UE.

Modifications of the general embodiment described above can be as follows:

For example, the second connection unit may be switched off in case the apparatus is unable to establish a connection or to perform a handover. That is, the moving relay node may switch off (as a whole, or at least the second connection unit providing the connection to the relay-UE). Thus, the relay-UEs will drop from the moving relay node and search for other macrocells. Hence, it can easily be achieved that the relay-UEs perform a handover.

Furthermore, the relay node may blink on a set of subframes comprising at least one subframe and to switch off the second connection unit. Alternatively, the relay node may blink on a set of resource blocks and inform the target network control node about the set of resource blocks on which blinking is performed. The set of resource blocks may be located in whole subframe(s) or only parts of a subframe, for example. That is, the single moving relay node may blink on certain resource blocks or subframes and then it either switches off or informs the target macrocell (e.g., target eNB) about the set of blank subframes.

Moreover, the processor of the relay node may blink on a set of resource blocks and inform the target network control node about the set of resource blocks on which blinking is performed.

This may not only be carried out by the relay node 2 described above, but also by a neighbor relay node which may interfere the relay node 2 (the neighbor relay node also being referred to as aggressor relay node in the following). The general structure of such an aggressor relay node is in principle the same as that of the relay node 2. Hence, according to a more general embodiment for such an aggressor relay node, an apparatus is provided which comprises a first connection unit configured to provide connection to a first network control node, a second connection unit configured to provide connection to at least one user equipment, and a processor which is configured to relay communication from the at least one network control node via the first connection unit to the at least one user equipment via the second connection unit and vice versa, and to perform blinking on a set of resource blocks.

Thus, the moving relay node and aggressor moving relay nodes may blink on certain resource blocks or subframes so that the relay-UEs can detect the target network control node(s) (target macrocell(s)) and the target network control node(s) may be informed about the set of these resource blocks (e.g., blank subframes).

Furthermore, the relay node may be configured to hand over the at least one user equipment blindly or to configure the at least one user equipment with measurements for preparing an inter-RAT handover or an inter-frequency handover. In more detail, the moving relay node may hand over its relay-UEs blindly or configure them with measurements B1 (inter-RAT HO) or A4 (inter-frequency HO), as explained below by referring to a specific embodiment 3.

Moreover, the relay node 2 and/or the aggressor relay node described above may receive an instruction from the serving network control node or from a network organizing device (e.g., a SON entity) informing about the set of resource blocks on which blinking is to be performed.

The DeNB 1 shown in FIG. 1 is an example for a corresponding serving network control node or apparatus which comprises a connection unit 12 configured to provide connection to at least a first relay node (such as the relay node 2 shown in FIG. 1) and a processor 11 which is configured to perform relaying communication to at least one user equipment via the connection unit through the at least first relay node, and to coordinate blinking on resource blocks of the first relay node and at least a second relay node (such as the aggressor relay node described above). Similar as the RN 2 described above, also the DeNB may comprise a memory 13 for storing data and programs, by means of which the processor 11 may carry out its corresponding functions.

That is, according to the modification described above, the serving DeNB coordinates the blinking of the moving and aggressor moving relay nodes.

The relay node 2 and the aggressor relay node(s) may coordinate the set of resource blocks on which blinking is to be performed. That is, for example, the relay node 2 and the aggressor relay node(s) may coordinate the blinking over X2 or any other interface without directly involving the serving DeNB. Such coordination may be as well managed by an entity/a device which is connected to the relay nodes over any interface.

The case described above that a handover of the relay node for maintaining a network connection of the at least one user equipment not possible may mean that no connection to the target network control node is possible at all, but it can also mean that the target network control node is not able to handle the full load of the handover, when a plurality of user equipments are connected i.e., served by the relay node 2.

In this case, the relay node may instruct only a part of the plurality of user equipments to perform a handover to a network control node. For this, the relay node may select the part of the plurality of user equipments which are to be instructed to perform a handover based on a criterion for the user equipments and/or based on service related information of the target network control node. The criterion may be quality of service (QoS) required for the UE, and the service related information may be the handover load offered by the target node. However, the relay node may ask for any kind of information which could help to decide which user equipments should be instructed to perform a handover.

For example, in case the target network control node (target DeNB) indicates that it cannot support the load involved with all user equipments served by the relay node 2, but could support a part of the user equipments, the relay node 2 will instruct a handover of only such a part.

Before selecting the part of the plurality of user equipments which are to be instructed to perform a handover, the relay node 2 may request information on the quality of service and/or on the handover load offered by the target network control node from the target network control node.

Further developments of the above-described general embodiments are described in the following by referring to specific embodiments 1 to 3.

### Specific Embodiment 1

### Backhaul HO Failure/Rejection or Partial Admittance

Before explaining the specific embodiment 1 in detail, the problem underlying this embodiment is described in more detail. In this embodiment, a scenario is assumed in which the vehicle is moving away from a serving DeNB 1 cell to another target DeNB 2 cell. For a seamless service the moving relay node should be handed over to the target DeNB 2 cell. However, for some reasons the handover (HO) of the moving relay node may fail or be rejected. It is noted that here any unsuccessful HO case is considered under this title. For instance, as an example of HO rejection, if the target cell is over-loaded it may not admit the moving relay node since the moving relay node is basically serving a multiple of RN-served UEs (relay-UEs) and the target cell cannot provide enough capacity to the wireless backhaul link of the moving relay node to continue serving that many UEs. On the other hand, the target DeNB 2 cell could admit a fraction of the relay-UEs and the rest of the relay-UEs could be served by overlaying 2G/3G cells or any other access node which is capable of serving the UEs, e.g. another DeNB 3.

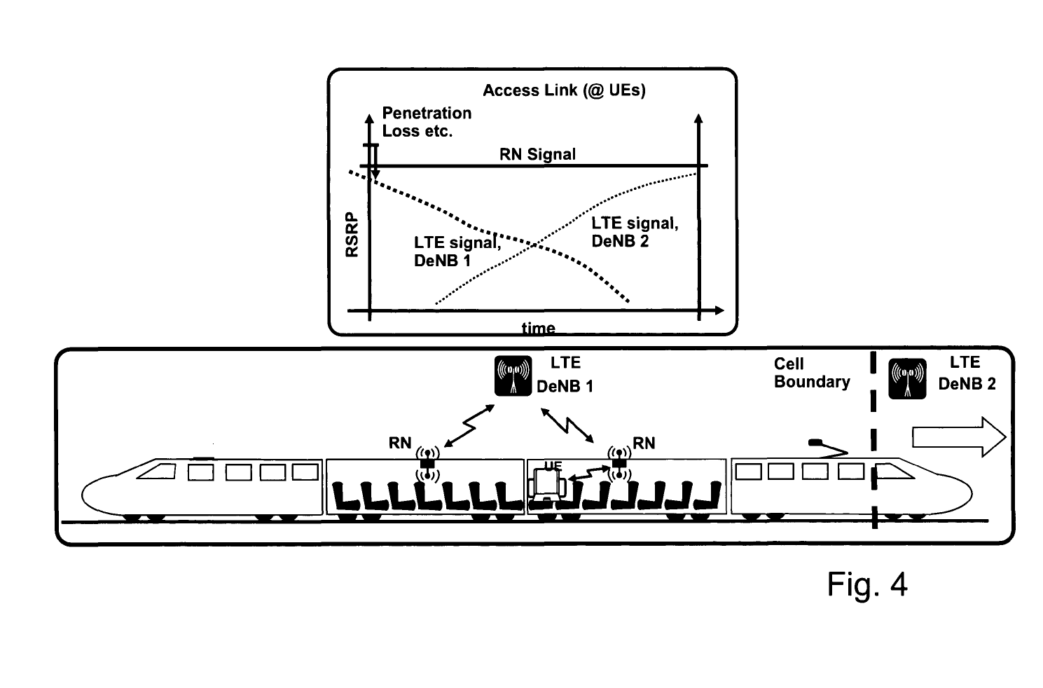

In such a situation, however, there might occur a problem that the relay-UEs, which are to be handed over to the target DeNB 2 cell, cannot detect the target DeNB 2 due to high receiver dynamic range caused by the moving relay nodes. In particular in a high speed train scenario as illustrated in FIG. 4 top drawing, the signal level of the serving mobile RN is much higher than other signals and the signal levels from the neighboring RNs can be also very high compared to the received signal levels of the DeNBs. Note that the RNs may have a Tx (transmission) power of 30 dBm and the DeNBs may have a Tx power of 46 dBm as given in 3GPP TR 36.814 v. 9.0.0. Yet, on the access link there is no penetration loss but the signals from DeNBs undergo penetration loss and they are farther away compared to the moving RNs. Accordingly, further measures are required to cope with such a backhaul HO failure in such a situation so that the relay-UEs can be handed over to other cells. An example scenario is demonstrated in FIG. 4 considering high speed train as the vehicle.

In the following, a solution according to the specific embodiment 1 with respect to the problems described above is described.

In the above scenario, due to a HO failure/rejection as described above, a fraction of the relay-UEs is to be handed over to the target DeNB 2 cell. These relay-UEs could be selected, e.g. according to their QoS requirements. That is, the relay-UEs which require a higher QoS could be handed over to the target DeNB 2 cell and other relay-UEs could be handed over to overlaying 2G/3G cells. As explained before, in the above scenario the relay-UEs to be handed over to the target DeNB 2 cell cannot detect its signal due to too high receiver dynamic range, as illustrated in FIG. 4. That is, the RSRP of the DeNB 1 which decreases due to the RN (and thus the relay-UE) separating from the DeNB 1 and the RSRP of the DeNB 2 which increases due to the RN (and thus the relay-UE) approaching DeNB 2 are both below the RSRP of the RN. It is emphasized here that the RSRP levels from DeNB 1 and DeNB 2 measured at the relay-UEs are decreased because of the penetration loss.

A preliminary solution is that the serving moving RN blinks some of the subframes so that the relay-UEs could detect the signal of the target DeNB 2 cell. However, as the neighboring moving RNs are transmitting on their access links, these RNs may be causing severe interference and hence these target relay-UEs cannot still detect the signal of the DeNB 2 cell. The remaining steps are as follows.
1. The backhaul HO failure/rejection is experienced. The moving RN and its serving DeNB 1 are aware of this failure/rejection.
2. The moving RN blinks a certain set of its access subframes and informs its

DeNB 1 about this set. The relay-UEs are informed to take measurements on these blank subframes.
3. DeNB 1 commands other aggressor RNs also to blink on this set of subframes. In case the aggressor RNs are served by another cell, DeNB 1 sends this message to that cell as well. As mentioned before, such coordination can also be managed between RNs without directly involving the DeNB over X2 or any other interface, or by a distinct or semi-distinct entity/device which connects to the RNs over any interface.
4. The relay-UEs can now do the measurements during these blank subframes and hand over procedure of these relay-UEs can be completed.
5. The target DeNB 2 cell is also informed about the set of these subframes such that it schedules the newly admitted relay-UEs during these subframes to prevent interference from the moving RNs.

Alternatively a partial admittance of the backhaul HO may take place. That is, the moving relay is handed over to the target DeNB with only serving a fraction of its all relay-UEs. For this purpose, the moving relay node requests the load of the target DeNB which implies the maximum load that the target DeNB can admit after a handover. Based on the offered load of the target DeNB, the moving relay node can estimate if its handover to the target DeNB would be successful or not. In case, a handover rejection is predicted, the moving relay node initiates the blank subframe and the following procedures as explained before. Note here that the number of blank subframes can be increased gradually so that a capacity loss is prevented in case the moving relay node could be handed over to the target DeNB. Furthermore, if the offered load is lower than the total load of the moving relay node, the moving relay node can handover a fraction of its all relay-UEs to other cells (eNB, 2G/3G, inter-frequency, another DeNB 3, etc.) until its load becomes lower or equal to the offered load such that its handover would be successful. Note that if some of these relay-UEs are to be handed over to eNB, blank subframes should still be coordinated to protect these UEs from deleterious access link interference.

It is further noted that similar information, i.e. the offered load of the target DeNB may be retrieved from the current HO preparation procedure; however, it might be too late for handing over the relay-UEs successfully and thus the backhaul HO might not be executed in time.

### Specific Embodiment 2

### Backhaul HO is not Possible

Before explaining the specific embodiment 2 in detail, the problem underlying this embodiment is described in more detail.

In this embodiment, a scenario is assumed in which the vehicle is moving away from a serving DeNB 1 cell to another eNB 2 cell. Note here that the next cell is served by an eNB and thus is not capable of serving an RN. This scenario can be illustrated similarly as in FIG. 4 by replacing ‘LTE DeNB 2’ by ‘LTE eNB 2’. This scenario is outlined as follows.
1. The moving relay node is served by an LTE DeNB 1 cell and detects that the target cell is an intra-RAT LTE eNB 2 cell that does not support relaying functionalities, e.g., a Rel. 8 eNB.
2. The relay-UEs have to be handed over to any other access node before they experience radio link failure (RLF) due to a backhaul link RLF.
3. The relay-UEs, however, detect a very strong signal from the access link of the moving relay node and cannot detect the signal of the target eNB 2 cell due to high receiver dynamic range in downlink. Therefore, the relay-UEs which are to be handed over to the eNB2 cannot be handed over due to the very strong signal from the moving relay node on the access link. The rest of the relay-UEs, which are to be handed over to other 2G/3G and/or inter-frequency eNB, follow the procedure given in the specific embodiment 3 described next.

### Preliminary Solution:

i. The moving relay node enables enhanced ICIC (eICIC), i.e., blinking some subframes, and configures the relay-UEs with event A3 (if they have not been configured yet) so that the relays-UE can measure the signal of the target cell and could send their measurement reports to the relay. Event A3 means that the relay-UEs are configured to send a measurement report when a neighboring cell becomes better than the serving cell (in this case, the moving relay node) by a specific offset.
ii. Further Problem: The relay-UEs still unable to detect the signal of the target eNB 2 cell because the access links of other relays are still interfering (other relays are not blinking).

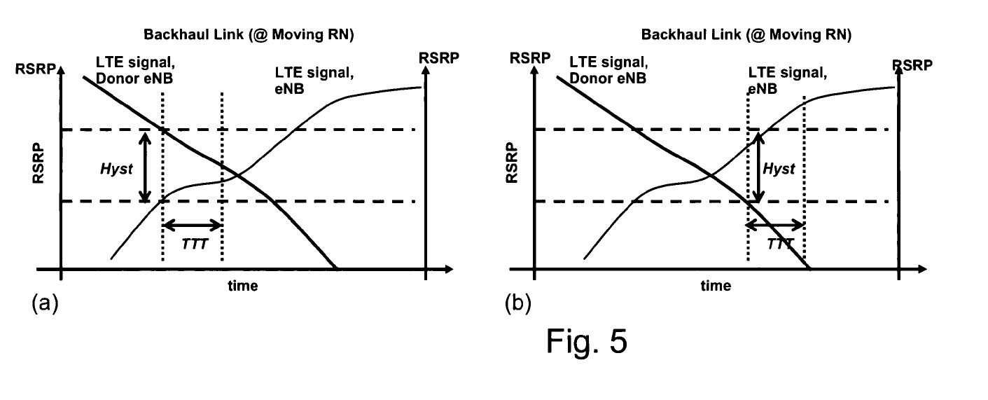

Thus, in the scenario according to the specific embodiment 2, the moving relay node is connected to a DeNB and detects a strong signal from an eNB which does not support relaying functionalities, i.e., no signal is detected from any neighboring DeNB. The relay-UEs will experience RLFs if they are not handed over to the target eNB. To avoid RLF, according to the second specific embodiment the following solution is proposed:
1. A new event called R3 as shown in FIG. 5 is proposed.

When configured with the event R3, the moving relay node will take measurements of the DeNB and the eNB. The event R3 expires according to one of the following proposals:

According to the proposal illustrated in FIG. 5(a), the event R3 expires when the signal of the DeNB is at most Hyst (as an example for a predetermined difference value) above the signal of the neighboring eNB or lower than the signal of the neighboring eNB for TTT time interval.

According to the proposal illustrated in FIG. 5(b), the event R3 expires when the signal of the DeNB is Hyst below the signal of the neighboring eNB for TTT time interval.
2. When the event R3 expires, the moving relay node sends the measurement report to the DeNB which in turn should inform the aggressor moving relay nodes to blink in order to allow the relay-UEs to detect the target signal of the eNB. As mentioned before, such coordination can also be managed between RNs without directly involving the DeNB over X2 or any other interface, or by a distinct or semi-distinct entity/device which connects to the RNs over any interface.
3. The relay-UEs can now start to measure the signal of the neighboring eNB during these blank subframes and send their A3 measurement reports, i.e., measurement event A3 is typically configured by moving relay node for intra-RAT handovers. Once the measurement reports are received from the relay-UEs, the moving relay node prepares their handovers to the target eNB.
4. The target eNB cell is also informed about the set of the blank subframes such that it schedules the newly admitted relay-UEs during these subframes to prevent interference from the moving RNs.

Thus, according to the specific embodiments 1 and 2 the following common measures are applied to resolve the aforementioned different problems:

The moving relay nodes (the serving and the other moving relay nodes) blink specific subframes in order to allow the relay-UEs to measure the signal of DeNB 2 (specific embodiment 1) or the target eNB (specific embodiment 2).

The DeNB 2/target eNB schedule the relay-UEs in those subframes to prevent interference from moving relay nodes.

The difference between the specific embodiments 1 and 2 is the event that triggers the above inventive steps: according to the specific embodiment 1, the trigger is the backhaul HO failure/rejection while according to the specific embodiment 2, the trigger is the R3 event.

That is, according to the specific embodiment 1, the trigger signal for the handover process may be of a form of HO failure or rejection message in case the target cell is a DeNB (as an example for a network control node capable of serving a relay node).

Alternatively, according to the specific embodiment 2, the trigger signal for the handover process may be of a form of the proposed event R3 in case the target cell is an eNB (as an example for a network control node not capable of serving a relay node).

Further alternatively, according to the specific embodiments 1 and 2, the trigger signal for the handover process may be of a form of the proposed event R3 in case the target cell is an eNB or a DeNB, where in case of DeNB offered HO load of the DeNB is requested and used.

### Specific Embodiment 3

### Backhaul HO is not Possible (Solutions for the Inter-RAT and Inter-Frequency Cases)

According to the specific embodiment 3 a scenario is assumed, in which the vehicle is moving away from a serving DeNB 1 cell to another 2G/3G cell or to an inter-frequency eNB case where different frequency carriers are used on the access link of the moving relay and in the inter-frequency eNB. Accordingly, the next cell is not capable of serving an RN. This scenario can be illustrated similarly as in FIG. 4 by replacing ‘LTE DeNB 2’ by ‘2G/3G cell or inter-frequency eNB cell’. This issue is outlined as follows.
1. There is no interference between LTE DeNB 1 and 2G/3G macro or inter-frequency eNB.
2. If the moving relay node detects that there is no target LTE signal but rather a strong 3G/2G signal, then the moving relay node has to hand over the relay-UEs to the target cell before experiencing RLFs.
3. To avoid RLFs of the relay-UEs, the relay should take further measures, which will be explained in the following.

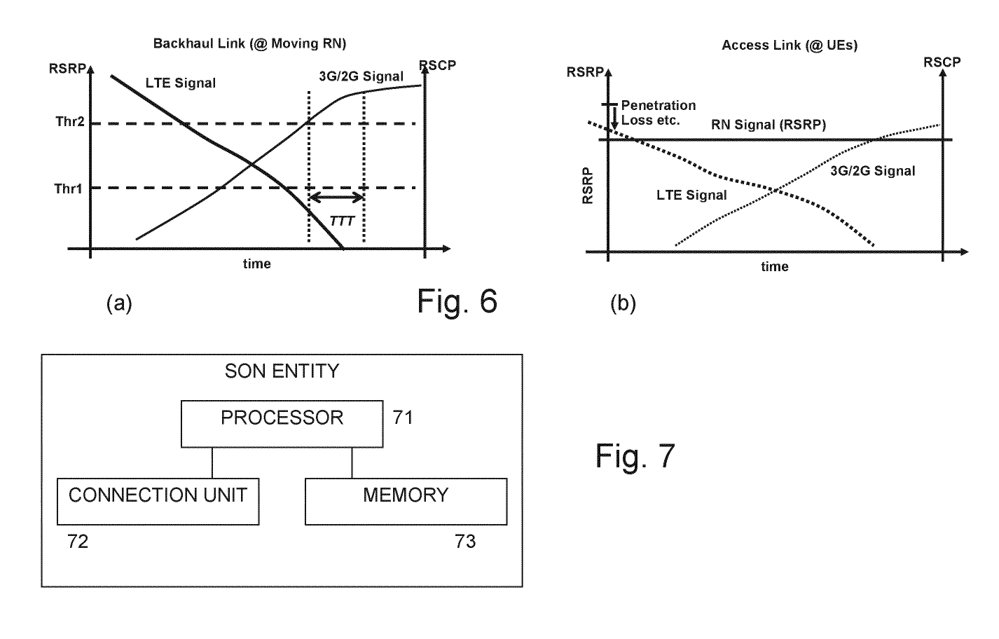

In the scenario according to the specific embodiment 2, as depicted in FIG. 6(a), the moving relay node is connected to a DeNB and detects that there is no signal from an intra-RAT DeNB or eNB, but rather a strong signal from a 2G/3G cell or an inter-frequency eNB. FIG. 6(b) shows how the signals are detected at the access link, i.e., by the relay-UEs. The relay-UEs will experience RLFs if they are not handed over to the target cell. Two methods are proposed to avoid the RLFs in this scenario:
1. The moving relay node hands over the relay-UEs blindly to the target cell.
2. The moving relay node configures the relay-UEs with measurement event B1 for inter-RAT handovers and event A4 for inter-frequency handovers. Event A4 means that a measurement is to be reported when the neighbor cell becomes better than an absolute threshold, event B1 is the same for the inter-RAT case. Once the event B1 or A4 expires, the relay-UEs send the measurement reports to the moving relay node which in turn prepares their handover to the target cell.

Note that in this scenario, the moving relay node does not blink as there is no interference between the DeNB and target 2G/3G cell or inter-frequency eNB.

It is noted that according to the specific embodiment 3, a methodology is employed where existing measurement events can be used to solve the problem. That is, the problem can be solved without needing additional signaling/enhancements, so that the solution according to this embodiment does not necessarily require amendments in standardization.

It is to be further noted that on the access link of moving relay multiple frequency carriers can be employed. Thus, between the moving relay and the inter-frequency (D)eNB there might be interference on common frequency carrier(s) and no interference on the other frequency carrier(s). Accordingly, for the common carrier(s) the procedures explained under the specific embodiment 1 or 2 can be followed while for the distinct carrier(s) the procedures explained under embodiment 3 can be followed. Furthermore, the moving relay(s) should blink only on the common carrier(s) only.

The invention is not limited to the embodiments described above (the general embodiment and its modification described in connection with FIG. 1 and the specific embodiments 1 to 3), but several modifications are possible.

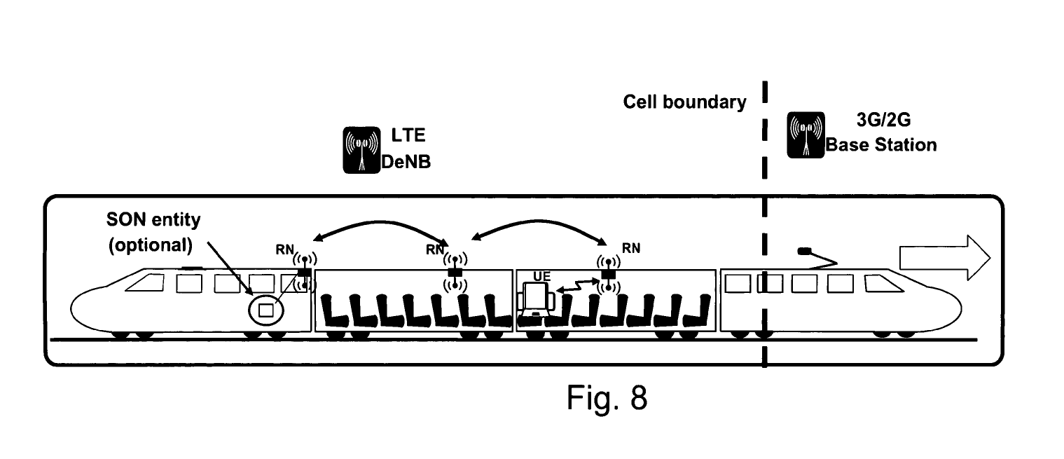

For example, as mentioned above, blinking on subframes (or resource blocks) between relay nodes can be coordinated by one of the relay nodes, between the RNs or by the DeNB, for example. However, as also indicated above, this coordination can be effected by a distinct or semi-distinct entity/device which connects to the RNs over any interface. An example for such an entity, which is also referred to as self-organizing network (SON) entity or network organizing device, is shown in FIG. 7. An example for a SON entity provided in the above-referenced high-speed scenario in a train is shown in FIG. 8.

FIG. 7 shows a simplified illustration of a SON entity 7 as an example for an apparatus according to a general embodiment of the present invention. The SON entity 7 comprises a processor 71 and a connection unit 72 which is configured to provide connection to at least a first relay node and a second relay node. The processor 71 is configured to coordinate blinking on a set of resource blocks by the at least first and second relay nodes.

For example, the first relay node may be the victim relay node and the second relay node may be the aggressor relay node, as described above. The SON entity 7 may receive information regarding blinking on the set of resource blocks from the first relay node and/or the at least second relay node.

Moreover, the SON entity 7 may be included in the DeNB, for example, so that the processor may also be configured to perform relaying communication to at least one user equipment via the connection unit through the at least first relay node.

Furthermore, it is noted that a blank subframe is a subframe during which a UE can detect a neighbor cell. Therefore, the serving moving relay node should configure such a subframe or should decrease its transmit power level below a threshold. Examples for such a blank subframe could be normal Almost Blank Subframes (ABS) or (Multi-Media Broadcast over a Single Frequency Network) MSBFN based ABS.

There are three types of RNs standardized in LTE-Advanced Release 10. In moving relay standardization 3GPP TR 36.416, the same type of relays considered for Rel. 10 are also considered, i.e. Type 1, Type 1a and Type 1b. The different types are explained in the following in line with 3GPP TR 36.814:
Type 1: This is an inband RN. Hence, to prevent self interference between backhaul and access links, a half-duplex operation is employed. During the backhaul subframes, the RN configures MBSFN subframes on the access link in the downlink. The beginning of an MBSFN subframe contains cell-specific reference signals. Release 8 UEs receive these signals and ignore the rest of the MBSFN subframe.
Type 1a: This is an outband RN. That is, on backhaul and access links different frequency bands are utilized. As there is no self interference, there is no need for MBSFN subframes on the access link. All the subframes in an LTE frame are utilized both on the access and backhaul links.
Type 1b: This is an inband RN with sufficient isolation between backhaul and access links. Thanks to this sufficient isolation, all the subframes in an LTE frame can be utilized and there is no need for MBSFN subframes. Considering the penetration loss between inside and outside the carriage, a sufficient isolation is assumed in the moving relay scenario and hence Type 1b is viable.

Accordingly, Type 1a and Type 1b scenarios require blank access link subframes discussed before in connection with the specific embodiments 1 and 2. The blank access link subframes can be also used for Type 1 scenario too, but the following methodology for the specific embodiments 1 and 2 results to be more efficient:
There are already blank subframes on the access link, i.e. MBSFN subframes. Hence, at least one of the MBSFN subframes needs to be coordinated among victim, i.e. serving moving relay, and aggressor moving RNs to enable relay-UEs to detect the target (D)eNB. This coordination can be effected either by a direct coordination between the RNs, or by the serving DeNB.

Since the relay-UEs to be handed over to the target macrocell need to be scheduled on the blank subframes, more than 1 MBSFN subframe can be coordinated among these moving-RNs. The set of the coordinated MBSFN subframes needs to be communicated to the target cell. The relay-UEs may be instructed to detect neighbor cell during these subframes.

Since a maximum of 6 subframes can be configured as MBSFN, if there is a need for more blanks subframes to schedule the handed-over relay-UEs additional blank subframes (e.g. ABSs) can be utilized.

The relay-UEs may be instructed to detect neighbor cell during the blank subframes in general.

The event R3 which is applied according to the specific embodiment 2 can be as well adapted to the specific embodiment 1. For the specific embodiment 1 (in case of partial admittance of backhaul HO), when the event R3 expires, the moving relay node requests the load of the target DeNB which implies the maximum load that the target DeNB can admit after a handover. The event R3 mechanism can provide the right time instant for such a request. In particular, receiving the load information too early might be suboptimum because the load conditions of the target DeNB might change and receiving the load information too late might result in unsuccessful handovers for both the relay-UEs and the backhaul of the moving relay. The rest of the procedure is the same as explained under specific embodiment 1.

The above-explained handover procedures should be initiated early enough to be able to handover the relay-UEs in case the moving relay node fails to hand over (see the scenarios above).

The above embodiments were described basically for LTE and LTE-A. However, the invention is not limited to these, and the measures suggested above can be applied to any case in which relaying is performed and the relay node has to perform a handover.

Furthermore, the embodiments can be arbitrarily combined.

Hence, according to the embodiments described above, it is possible to overcome problems which may occur when a due to a movement of a relay node and handover of the relay node to another DeNB may fail.

According to several aspects of embodiments of the present invention, an apparatus and a method are provided, by which communication from at least one network control node is relayed to at least one user equipment and vice versa, it is detected whether a connection to a network control node or a handover of the apparatus from a serving network control node to a target network control node for maintaining a network connection of the at least one user equipment is required but not possible, and, in case the connection or the handover is not possible, the at least one user equipment is instructed to perform a handover to a network control node.

According to another aspect of embodiments of the present invention, an apparatus is provided which comprises means for relaying, in a relay node, communication from at least one network control node to at least one user equipment and vice versa, means for detecting whether a connection to a network control node or a handover of the relay node from a serving network control node to a target network control node for maintaining a network connection of the at least one user equipment is required but not possible, and means for instructing the at least one user equipment to perform a handover to a network control node, in case the connection or the handover is not possible.

According to further aspect of embodiments of the present invention, an apparatus is provided which comprises means for coordinating blinking on a set of resource blocks by at least a first and a second relay node. This apparatus may further comprise means for receiving information regarding blinking on the set of resource blocks from the first relay node and/or the at least second relay node.

According to another aspect of embodiments of the present invention, an apparatus is provided which comprises means for relaying communication from at least one network control node to at least one user equipment and vice versa, and means for performing blinking on a set of resource blocks.

According to still further aspect of embodiments of the present invention, an apparatus is provided which comprises means for performing, in a network control node, relaying communication to at least one user equipment through a relay node, means for receiving a request from the relay node for service related information of the network control node, and means for sending an answer to the request to the relay node.

It is to be understood that any of the above modifications can be applied singly or in combination to the respective aspects and/or embodiments to which they refer, unless they are explicitly stated as excluding alternatives.

For the purpose of the present invention as described herein above, it should be noted that
method steps likely to be implemented as software code portions and being run using a processor at a network element or terminal (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the invention in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above, eNode-B etc. as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined apparatuses, or any one of their respective means) can be implemented as individual devices, units or means, but this does not exclude that they are implemented in a distributed fashion throughout the system, as long as the functionality of the device, unit or means is preserved;
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

It is noted that the embodiments and examples described above are provided for illustrative purposes only and are in no way intended that the present invention is restricted thereto. Rather, it is the intention that all variations and modifications be included which fall within the spirit and scope of the appended claims.

1. An apparatus comprising:
at least one processor; and
at least one memory including computer program code, the at least one memory and the computer program code configured, with the at least one processor, to cause the apparatus to perform at least the following:
provide connection to at least one network control node via a first connection unit,
provide connection to at least one user equipment via a second connection unit,
relay communication from the at least one network control node to the at least one user equipment and vice versa,
detect whether a connection to a network control node or a handover of the apparatus from a serving network control node to a target network control node for maintaining a network connection of the at least one user equipment is required but not possible, and,
in case the connection or the handover is not possible,
instruct the at least one user equipment to perform a handover to a network control node.

2. The apparatus according to claim 1, wherein said at least one memory and the computer program code are further configured, with the at least one processor, to cause the apparatus to perform:
switch off the second connection unit in case the apparatus is unable to establish a connection or to perform a handover.

3. The apparatus according to claim 1, wherein said at least one memory and the computer program code are further configured, with the at least one processor, to cause the apparatus to perform:
blink on a set of resource blocks and to switch off the second connection unit.

4. The apparatus according to claim 1, wherein said at least one memory and the computer program code are further configured, with the at least one processor, to cause the apparatus to perform:
blink on a set of resource blocks and inform the target network control node about the set of resource blocks on which blinking is performed.

5. The apparatus according to claim 1, wherein said at least one memory and the computer program code are further configured, with the at least one processor, to cause the apparatus to perform:
hand over the at least one user equipment blindly or
configure the at least one user equipment with measurements for preparing an inter radio access technology handover or an inter-frequency handover.

6. The apparatus according to claim 4, wherein said at least one memory and the computer program code are further configured, with the at least one processor, to cause the apparatus to perform:
receive an instruction from the serving network control node or a network organizing device informing about the set resource blocks on which blinking is to be performed.

7. (canceled)

8. The apparatus according to claim 6, wherein said at least one memory and the computer program code are further configured, with the at least one processor, to cause the apparatus to perform:
instruct the handover of the at least one user equipment when a message informing that the handover of the apparatus from the serving network control node to the target network control node for maintaining the network connection of the at least one network control node is not possible is received via the first connection unit in case the target network control node is a network control node capable of serving a relay node.

9. The apparatus according to claim 6, wherein said at least one memory and the computer program code are further configured, with the at least one processor, to cause the apparatus to perform:
instruct the handover of the at least one user equipment when a certain measurement event expires in case the target network control node is a network control node not capable of serving a relay node or a network control node capable of serving a relay node, wherein in the certain measurement event, the processor is configured to perform measurements of transmission power of the serving network control node and of the target network control node and the event expires
when the measured transmission power of the serving network control node is at most a predetermined difference value over the measured transmission power of the target network control node for a predetermined time, or
when the measured transmission power of the serving network control node is below the measured transmission power of the target network control node by at least a predetermined difference value for a predetermined time.

10. The apparatus according to claim 1, wherein
a plurality of user equipments is connected with the second connection unit, and, wherein
said at least one memory and the computer program code are further configured, with the at least one processor, to cause the apparatus to perform:
instruct only a part of the plurality of user equipments to perform a handover to a network control node.

11-13. (canceled)

14. An apparatus comprising:
at least one processor; and
at least one memory including computer program code, the at least one memory and the computer program code configured, with the at least one processor, to cause the apparatus to perform at least the following:
provide a connection to at least a first and a second relay node via a connection unit, and
coordinate blinking on a set of resource blocks by the at least first and the second relay node.

15. The apparatus according to claim 14, wherein said at least one memory and the computer program code are further configured, with the at least one processor, to cause the apparatus to perform:
receive information regarding blinking on the set of resource blocks from the first relay node and/or the at least second relay node.

16. (canceled)

17. An apparatus comprising:
at least one processor; and
at least one memory including computer program code, the at least one memory and the computer program code configured, with the at least one processor, to cause the apparatus to perform at least the following:
provide connection to a first network control node via a first connection unit,
provide connection to at least one user equipment via a second connection unit,
relay communication from the at least one network control node via the first connection unit to the at least one user equipment via the second connection unit and vice versa, and
perform blinking on a set of resource blocks.

18. The apparatus according to claim 17, wherein said at least one memory and the computer program code are further configured, with the at least one processor, to cause the apparatus to perform:
receive an instruction to blink on a set of resource blocks from the serving network control node or a network organizing device, and/or
coordinate blinking on a set of resource blocks with another relay node.

19. An apparatus comprising:
at least one processor; and
at least one memory including computer program code, the at least one memory and the computer program code configured, with the at least one processor, to cause the apparatus to perform at least the following:
provide connection to a first relay node via a connection unit,
perform relaying communication to at least one user equipment via the connection unit through the relay node,
receive, via the connection unit, a request from the relay node for service related information of the apparatus, and
send an answer to the request to the relay node via the connection unit.

20. The apparatus according to claim 19, wherein
the service related information requested by the relay node comprises a handover load offered by the apparatus.

21. A method comprising
relaying, in a relay node, communication from at least one network control node to at least one user equipment and vice versa,
detecting whether a connection to a network control node or a handover of the relay node from a serving network control node to a target network control node for maintaining a network connection of the at least one user equipment is required but not possible, and,
in case the connection or the handover is not possible, instructing the at least one user equipment to perform a handover to a network control node.

22-42. (canceled)
